(19) United States
(12) Patent Application Publication
(10) Pub. No.: US 2006/0151240 A1
(43) Pub. Date: Jul. 13, 2006

(54) Device for evacuating people from a building

(76) Inventor: Werner Hafliger, Mettmenstetten (CH)

Correspondence Address: WENDEROTH, LIND & PONACK, L.L.P., 2033 K STREET N. W., SUITE 800, WASHINGTON, DC, 20006-1021, US

(21) Appl. No.: 10/511,299

(22) PCT Filed: Mar. 22, 2003
(86) PCT No.: PCT/EP03/03005

§ 371 Date: Jul. 18, 2005

(30) Foreign Application Priority Data
Apr. 18, 2002 (CH) 0650/02

(51) Int. Cl. A62B 1/20

(52) U.S. Cl. 182/48

(57) ABSTRACT

The invention relates to a device for evacuating people from a building (2) comprising a part which can be placed into a functional position from a non-functional position. In the functional position, said part forms a rescue channel (29) leading from an upper floor of a building to a floor area (20). The part forming the rescue channel (29) is embodied as a tube (7) which is folded together when in the non-functional position, said tube extending in an essentially vertical manner with respect to the building wall (22) when in the functional position. Braking means are provided for the safe conveyance of people through the rescue channel (29) to the floor area (20). As a result of said device, people in an emergency situation, for example a fire, can be evacuated from a building in a fast and secure manner.

The invention concerns a device for evacuating people from a building according to the generic term of claim 1.

A device of this type is known for example from DE-A-41 08 979, which discloses an inflatable, slanting rescue chute, in which a closed ring of longitudinally-extending tubes can be brought from a non-functional position by inflating the tubes into a functional position in which it forms a rescue channel leading from an upper storey of the building to ground level. This rescue chute is unsuitable for evacuation from high buildings, since there is usually too little space for the rescue chute in view of the angle of inclination necessary for the safe conveyance of people. Also, problems of flexural strength of the tube increase with the length of the slide.

The present invention is based on the problem of creating a device of the aforementioned type which enables rapid and safe evacuation even from high buildings.

This problem is solved according to the invention by a device with the characteristics of claim 1.

Other preferred embodiments of the device according to the invention form the subject matter of the dependent claims.

Because the part forming the rescue channel is in the form of a tube which is folded together in the non-functional position, which when unfolded into the functional position is disposed essentially vertically or at a slight angle to the building wall, whereby braking means are provided for the safe conveyance of people through the rescue channel to ground level, the device of the invention can be used for rapid evacuation, even from very high buildings. In an especially preferred embodiment of the braking means in the form of an annular air cushion which is inflatable in the manner of an airbag on the inside of the tube, people can be conveyed—one after another—through the rescue channel which runs essentially vertically, thereby sliding through the individual air cushions, without there being any freefall.

The invention is next explained in more detail with the aid of the drawings, which show:

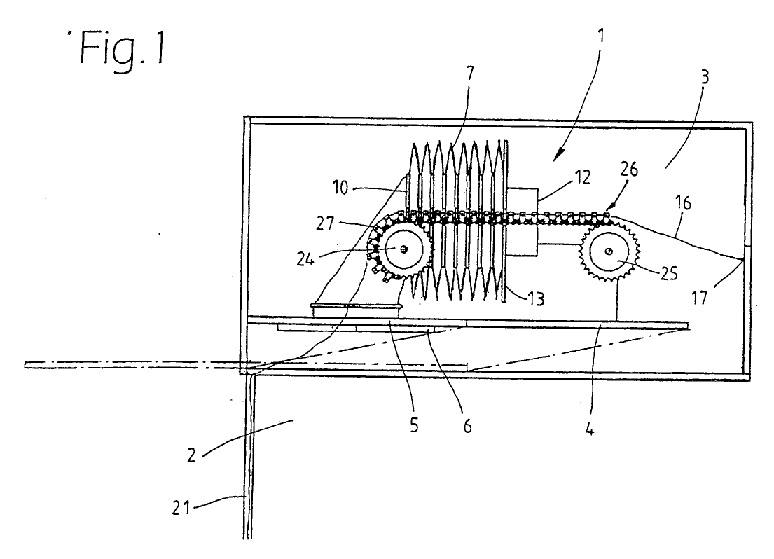

FIG. 1 an embodiment of a device according to the invention in a non-functional position; and

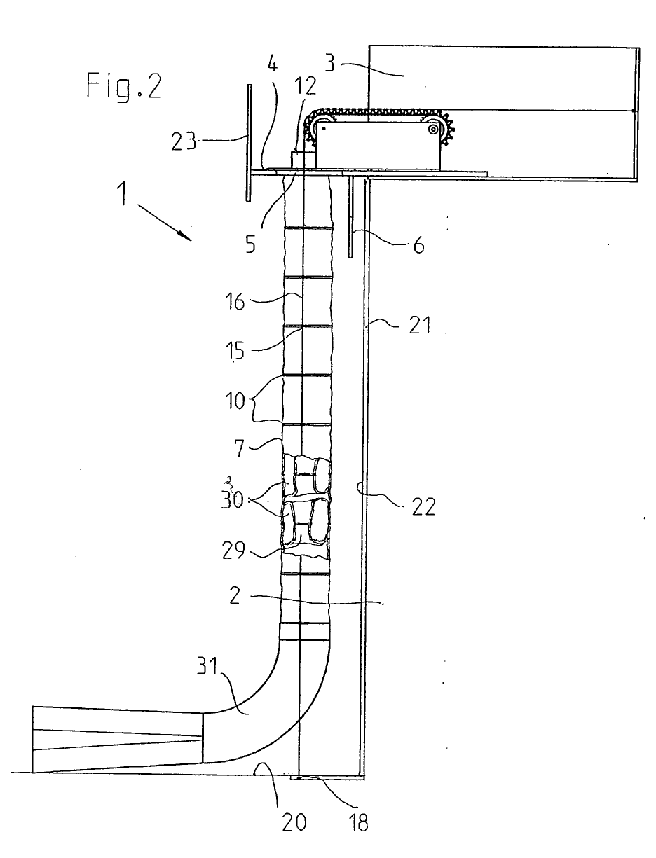

FIG. 2 the device in a functional position in partial sectional representation.

FIGS. 1 and 2 show a device 1 for the evacuation of people from a building 2, which is housed, in a non-functional position shown in FIG. 1 in an enclosure 3, which is in an upper storey of the building 2. The device 1 is thereby disposed on a plateau 4 which can be partially extended outwards from the enclosure 3 or from the building 2.

FIG. 2 shows the plateau 4 in the position projecting from the building 2, which is also indicated by a dotted line in FIG. 1. The plateau 4 is provided with a base opening 5, which is kept closed in the non-functional position according to FIG. 1 by means of a flap 6, and which is disposed in the area of the plateau 4 which can be extended out of the building 2.

The device 1 comprises a tube 7 which folds together in the manner of a concertina, which is equipped with a number of transversal rings distributed over its length at a distance from each other. The transversal rings 10 are pressed close together when the tube is in the folded position, as can be seen from FIG. 1. The tube 7 is connected at one end with an entrance part 13 displaying an entry opening 12 and disposed with the other end in front of the base opening 5 of the plateau 4. The folded tube part, equipped with transversal rings 10 and the axis of the entry opening 12 in the non-functional position, are disposed parallel to the plateau 4, i.e. horizontally.

The transversal rings 10 are each provided with at least one opening, indicated in FIG. 2 by reference number 15. A tensioning rope 16 is passed through the openings 15 of the individual transversal rings 10, said rope extending between two fixed points 17, 18, one of which is disposed in the rear area of the enclosure 3 (cf. FIG. 1) and the other is assigned to ground level 20 (FIG. 2).

The tensioning rope 16 is passed over the upper side of a tensioning and transport device 26. The tensioning and transport device 26 resting on the plateau 4 comprises two wheels 24, 25 and a transport chain 27 driven by said wheels, said chain co-operating with the transversal rings 10 of the tube 7. In the non-functional position of the device 1 shown in FIG. 1 the tensioning rope 16 is not under tension and is advantageously passed within a groove 21 along the building wall 22. When the plateau is extended this tensioning rope 16, which is fixed to the fixed points 17, 18, is torn out of the groove 21 and brought into an extended position approximately parallel to the building wall 22.

In order to evacuate people from a building 2 in an emergency, the plateau 4 provided in the enclosure 3, together with the tensioning and transport device 26 disposed thereon, is extended outwards into the position shown in FIG. 2, whereby the building wall 22 at this point is formed by a wall element 23 or similar disposed on the plateau, whereby this wall element 23 effects an opening in the building wall when extension occurs. When extension occurs, moreover, the tensioning rope 16 is ripped out of the groove 21 on the building front and tensioned between the reference points 17, 18 by the roller 24 which moves with the plateau 4.

As soon as the plateau 4 has been extended and has reached its end position, the flap 6 is also automatically pivoted down and the base opening 5 in the plateau 4 is opened, and the tube 7 falls—under the influence of gravity—downwards through this base opening 5 and unfolds itself automatically. Thereby the transversal rings 10 slide along the tensioning rope 16 (or the tensioning ropes 16; preferably each transversal ring 10 is provided with two opposing openings 15 and there are two tensioning ropes 16 provided). The tube 7 is held fast at the upper end by the entrance part 13 resting on the plateau 4, which has been brought into this position, in which the entry opening 12 is disposed co-axially with the base opening 5, with the aid of the tensioning and transport device 26. Thus the tube 7 which has been let down forms a rescue channel 29 leading down from the upper floor to ground level 20.

Each transversal ring 10 is assigned, on the inside of the tube 7, an annular air cushion which is inflatable in the manner of an airbag, which is automatically inflated when the tube 7 is let down. The air cushions 30 form the braking means for the people to be conveyed through the tube 7 and prevent any freefall in the practically vertical tube arrangement. The people entering the tube 7 through the entry opening 12 slide—one by one—from one air cushion 30 to the next. The elastic flexibility of the air cushions 30 in radial and axial direction allows the braked passage of people of varying heights and sizes respectively.

At the lower end of the tube 7 there can be attached—as can be seen from FIG. 2—an essentially arched exit part 31, which is not equipped with any more braking means, and which facilitates a rapid exit.

Instead of the annular air cushions 30 which are inflatable in the manner of an airbag, other braking means for the safe conveyance of people are possible. Thus for example air blown from a fan into the tube from below could guarantee the necessary braking resistance.

The tube 7 preferably consists of a flame-resistant and heat-insulating material, so that even in the event of a fire, there is no risk to people being conveyed through the tube. Another possibility would be the application of a transparent material for better supervision of the evacuation process or else to provide windows in the tube.

An essential advantage of the device according to the invention lies in its independence from the building infrastructure, e.g. from electrical power.

The plateau 4 can advantageously form a part of a container which can be extended out of the building 2, in which the entire device is housed in the non-functional position, whereby this container is not visible on the building 2 from the outside. Several such devices per storey and devices in several stories could be provided.

1-11. (canceled)

12. Device for evacuating people from a building (2), comprising a part which will be placed into a functional position from a non-functional position, which in the functional position forms a rescue channel (29) leading from an upper floor of a building to ground level (20), wherein
the part forming the rescue channel (29) is embodied as a tube (7) which is folded together when in the non-functional position, said tube extending in an essentially vertical manner with respect to the building wall (22), whereby braking means are provided for the safe conveyance of people through the rescue channel (29) to ground level (20).

13. Device according to claim 12, wherein the tube (7) is equipped with a number of transversal rings (10) distributed over its length at a distance from each other, which are each equipped with at least one opening (15) for the passage of a tensioning rope (16) which determines the arrangement of the tube (7) in the functional position.

14. Device according to claim 13, wherein the tube (7) equipped with the transversal rings (10) is designed so that it can be folded together or extended in the manner of a concertina.

15. Device according to claim 13, wherein each transversal ring (10) is assigned an annular air cushion (30) which is inflatable in the manner of an airbag when the tube (7) is in the functional position, whereby the air cushions (30) assigned to the transversal rings (10) form the braking means for the safe conveyance of people through the rescue channel (29).

16. Device according to claim 12, wherein the tube (7), when folded in the non-functional position, is disposed in an enclosure (3) on the upper floor on a plateau (4) which can be extended from the building, whereby the tube can unfold automatically when the plateau (4) is extended, through a base opening (5) of the latter, towards the ground (20).

17. Device according to claim 16, wherein the tube (7) is equipped with a number of transversal rings (10) distributed over its length at a distance from each other, which are each equipped with at least one opening (15) for the passage of a tensioning rope (16) which determines the arrangement of the tube (7) in the functional position,
wherein in the functional position with the plateau (4) extended, the tensioning rope (16) is stretched between two fixed points (17, 18) assigned firstly to the upper floor and secondly to ground level (20), whereby when the plateau (4) is being extended, said rope can be ripped out of a groove (21) provided in the building wall (22) and brought into an approximately vertical position.

18. Device according to claim 16, wherein the tube (7) is connected at one end with an entrance part (13) displaying an entry opening (12), whereby when the plateau (4) is extended, the entrance part (13) can be brought into a position in which the entry opening (12) is disposed coaxially with respect to the ground opening (5) and the entrance part (13) is resting on the plateau (4).

19. Device according to claim 12, wherein the functional position an essentially arched exit part (31) is attached to the lower end of the tube (7).

20. Device according to claim 16, wherein the plateau (4) forms part of a container which can be extended from the building (2), in which container the entire device is accommodated in the non-functional position.

21. Device according to claim 12, wherein the tube (7) is made from flame-resistant material.

22. Device according to claim 12, wherein the tube (7) is made from transparent material, or that it displays windows.
